(19) United States
(12) Patent Application Publication
(10) Pub. No.: US 2010/0171684 A1
(43) Pub. Date: Jul. 8, 2010

(54) PLASMA DISPLAY DEVICE

(75) Inventors: Su-Jun PARK, Suwon-si (KR); Seung-Hun CHAE, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD., Suwon-si (KR)

(21) Appl. No.: 12/652,817

(22) Filed: Jan. 6, 2010

(30) Foreign Application Priority Data
Jan. 6, 2009 (KR) 10-2009-0000788

(51) Int. Cl. H01J 17/49; G09G 3/28

(52) U.S. Cl. 345/60; 313/584

(57) ABSTRACT

A plasma display device wherein a circuit pattern is formed on a substrate of one end of an address electrode of a plasma display panel, the circuit pattern is connected with a logic board assembly by a tape carrier package, and the tape carrier package is stably held. The plasma display device includes a plasma display panel having a pair of substrates. A chassis base is used to support the plasma display panel. A printed circuit board assembly is mounted on the chassis base. Circuit patterns that include terminals are formed on the substrate formed with address electrodes and signal lines applying power and control signals. A first tape carrier package having a first end connected to the terminals and a second end forming a free end and that mounts a drive IC between the first end and the second end. A second tape carrier package connects the signal line with the printed circuit board assembly. A cover plate that covers the first tape carrier package and the second tape carrier package.

### CLAIM OF PRIORITY

This application makes reference to, incorporates the same herein, and claims all benefits accruing under 35 U.S.C. §119 from an application earlier filed in the Korean Intellectual Property Office on Jan. 6, 2009 and there duly assigned Serial No. 10-2009-0000788.

### BACKGROUND OF THE INVENTION

1. Field of the Invention

The described technology relates to a plasma display device.

2. Description of the Related Art

In general, a plasma display device includes a plasma display panel (PDP) that displays images, a chassis base that supports the plasma display panel, and a plurality of printed circuit board assemblies that are mounted on the chassis base.

As is known, the plasma display panel excites phosphors by using vacuum ultraviolet (VUV) rays emitted from plasma obtained by gas discharge, and implements images by visible light of colors such as red (R), green (G), and blue (B) that is generated while the excited phosphors are stabilized.

The plasma display device may includes a plurality of printed circuit board assemblies that can share various functions for controlling electrodes formed in the plasma display panel. The printed circuit board assemblies need to be provided to a minimum for simplifying the structure of the device.

### SUMMARY OF THE INVENTION

An exemplary embodiment of the present invention provides a plasma display device wherein a circuit pattern is formed on a substrate of one end of an address electrode of a plasma display panel (PDP), the circuit pattern is connected with a logic board assembly by a tape carrier package, and the tape carrier package is stably held.

Another exemplary embodiment of the present invention provides a plasma display device that can protect a drive IC mounted in a tape carrier package and the tape carrier package, such that breakage of the drive IC and damage to the tape carrier package are prevented.

According to an exemplary embodiment of the present invention, there is provided a plasma display device including: a plasma display panel that includes a pair of substrates facing each other and implements images; a chassis base that supports the plasma display panel at an opposite side to that where the images are implemented; terminals that are formed on the substrate formed with address electrodes among the pair of substrates and connected to the address electrodes; circuit patterns that include signal lines applying power and control signals; a first tape carrier package that has a first end connected to the terminals and a second end forming a free end and that mounts a drive IC between the first end and the second end; and a cover plate that is mounted on the chassis base while covering the first tape carrier package, wherein the second end of the first tape carrier package and the cover plate may be coupled to each other.

The first tape carrier package has penetration holes formed at the second end, and the cover plate may include insertion protrusions that are formed corresponding to the penetration holes and inserted into the penetration holes.

The penetration holes may be formed at both sides of the drive IC as pairs. The penetration holes may be formed to be round, and the insertion protrusions may be formed to be cylindrical to correspond thereto.

The first tape carrier package has opening grooves whose sides are opened at the second end, and the cover plate may include the insertion protrusions that are formed corresponding to the opening grooves and are inserted into the opening grooves.

The opening grooves may be formed at both sides of the drive IC as pairs.

The opening grooves may each include a circular portion corresponding to the insertion protrusion and an opening portion that is smaller than a diameter of the circular portion.

The first tape carrier package has the penetration holes and opening grooves at both sides of the second end, and the cover plate may include the insertion protrusions that are formed corresponding to the penetration holes and the opening grooves and are inserted into the penetration holes and the opening grooves.

The plasma display device may further include a printed circuit board assembly mounted on the chassis base at an opposite side of the plasma display panel; and a second tape carrier package that mutually connects the signal lines with the printed circuit board assembly.

The printed circuit board assembly to which the second tape carrier package is connected may be a logic board assembly that receives video signals from the outside, generates control signals required to control the plasma display panel, and applies them to the printed circuit board assemblies.

In the second tape carrier package that is bent between a lower end of the plasma display panel and the cover plate, the second end may be disposed to be more adjacent to the cover plate than to a curved line of the second tape carrier package that connects the circuit pattern and the printed circuit board assembly while being bent at the lower end of the plasma display panel.

The cover plate includes a horizontal surface and a vertical surface that are at right angles to each other, and may further include a heat dissipation pad that is interposed between the horizontal surface and the second tape carrier package. The drive IC mounted in the first tape carrier package may be closely attached to the heat dissipation pad.

As described above, according to an exemplary embodiment of the present invention, the first tape carrier package (TCP) that connects the circuit pattern and the logic board assembly is coupled with the cover plate, thereby making it possible to stably hold the first tape carrier package.

The penetration holes or the opening grooves are formed in the first tape carrier package and the insertion protrusions are formed on the cover plate corresponding thereto to fix the second end that is in a free state, thereby making it possible to prevent the breakage of the drive IC and the damage to the tape carrier package.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematically exploded perspective view showing a plasma display device according to a first exemplary embodiment of the present invention;

FIG. 2 is a cross-sectional view taken along line II-II of FIG. 1;

FIG. 3 is a cross-sectional view taken along line III-III of FIG. 1;

FIG. 4 is a perspective view viewed from an upper front part of the plasma display panel of FIG. 1;

FIG. 5 is an exploded perspective view of a cover plate and a first tape carrier package (TCP); and

FIG. 6 is an exploded perspective view of the cover plate and the first tape carrier package (TCP) in the plasma display device according to the second exemplary embodiment of the present invention.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature, and not restrictive. Like reference numerals designate like elements throughout the specification.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being to another element, one element may be not only directly connected to the another element but instead may be indirectly connected to the another element via one or more other elements. Also, when an element is referred to as being “on” another element, it can be directly on the another element or be indirectly on the another element with one or more intervening elements interposed herebetween. Further, some of the elements that are not essential to the complete description of the invention have been omitted for clarity. In addition, like reference numerals refer to like elements throughout.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

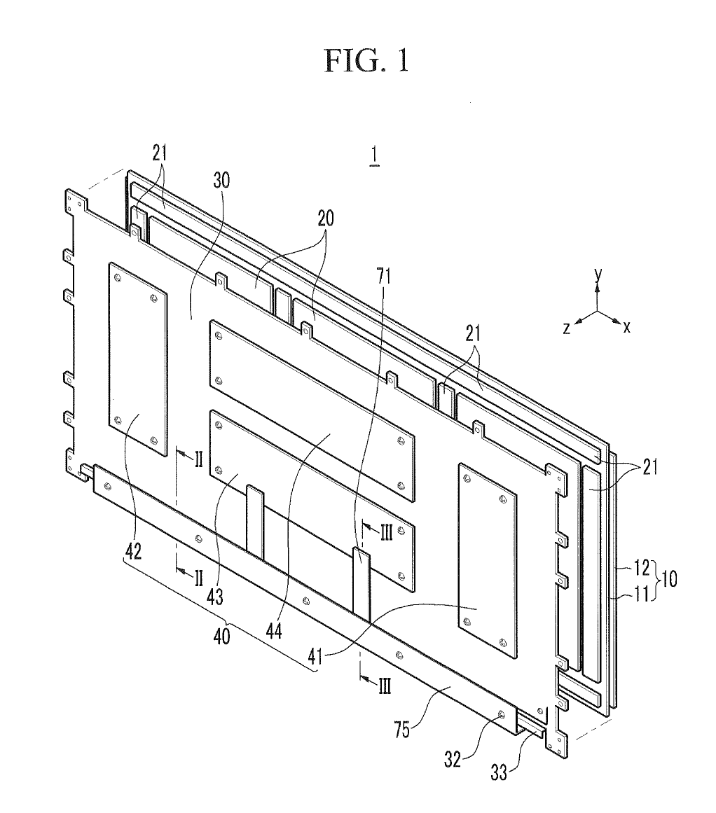

FIG. 1 is a schematically exploded perspective view showing a plasma display device according to a first exemplary embodiment of the present invention

Referring to FIG. 1, a plasma display device 1 according to an exemplary embodiment includes a plasma display panel 10 that displays images using gas discharge, a heat dissipation sheet 20, a chassis base 30, and printed circuit board assemblies 40.

The present exemplary embodiment relates to a portion that connects the plasma display panel 10 and the printed circuit board assemblies 40, and therefore a detailed description of the plasma display panel 10 will be omitted herein.

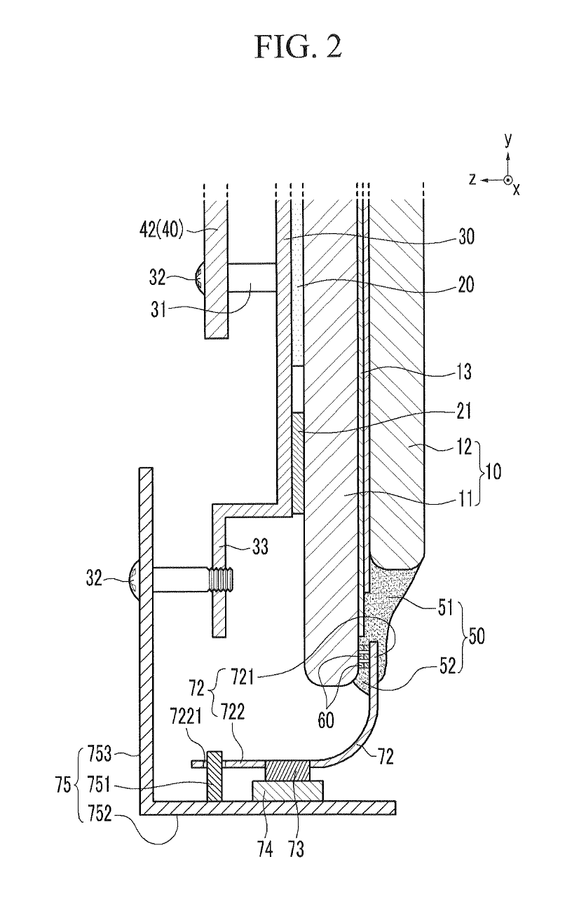

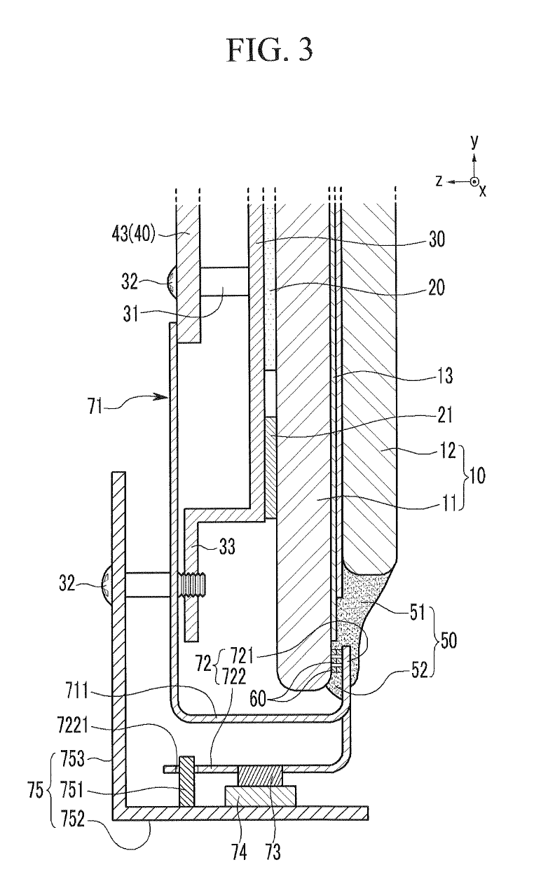

Schematically describing, the plasma display panel 10 includes a rear substrate 11 and a front substrate 12 that are made of glass, and electrodes, for example a sustain electrode, a scan electrode (not shown), and an address electrode 13, that generate gas discharge from discharge cells (not shown) between the substrates 11 and 12 (see FIGS. 2 and 3).

The heat dissipation sheet 20 is configured to be provided between the plasma display panel 10 and the chassis base 30 to rapidly diffuse heat generated from the plasma display panel 10 due to the gas discharge.

The chassis base 30 is attached to the rear substrate 11 of the plasma display panel 10 by a double-sided adhesive tape 21, with the heat dissipation sheet 20 therebetween, to support the plasma display panel 10.

The printed circuit board assemblies 40 are configured to drive the plasma display panel 10, and are electrically connected (not shown) to the plasma display panel (PDP) 10.

The printed circuit board assembly 40 is formed of a plurality of printed circuit board assemblies so as to share and perform functions of driving the plasma display panel 10.

For example, the printed circuit board assemblies 40 include a sustain board assembly 41 that controls the sustain electrode (not shown), a scan board assembly 42 that controls a scan electrode (not shown), a logic board assembly 43 that receives image signals from the outside, generates control signals each required to drive the address electrodes 13, the sustain electrode, and the scan drive, and applies them to the corresponding board assemblies, and a power supply board assembly 44 that supplies power required to drive each of the board assemblies.

FIG. 2 is a cross-sectional view taken along line II-II of FIG. 1, and FIG. 3 is a cross-sectional view taken along line III-III of FIG. 1.

Referring to FIGS. 2 and 3, the plasma display panel 10 is mounted at the front of the chassis base 30 and the printed circuit board assemblies 40 are mounted at the rear of the chassis base 30.

The printed circuit board assemblies 40 are disposed on a plurality of bosses 31 provided on the chassis base 30, and are mounted on the chassis base 30 by engaging a set screw 32 with the boss 31.

The sustain board assembly 41 is connected to the sustain electrode through a tape carrier package (not shown), and the scan board assembly 42 is connected to the scan electrode through a tape carrier package (not shown). Unlike the related art, the exemplary embodiment of the present invention does not include an address buffer board that separately controls the address electrodes 13. That is, the printed circuit board assembly 40 does not need the address buffer board. Therefore, the structure of the plasma display device 1 is simplified and the manufacturing cost thereof can be reduced.

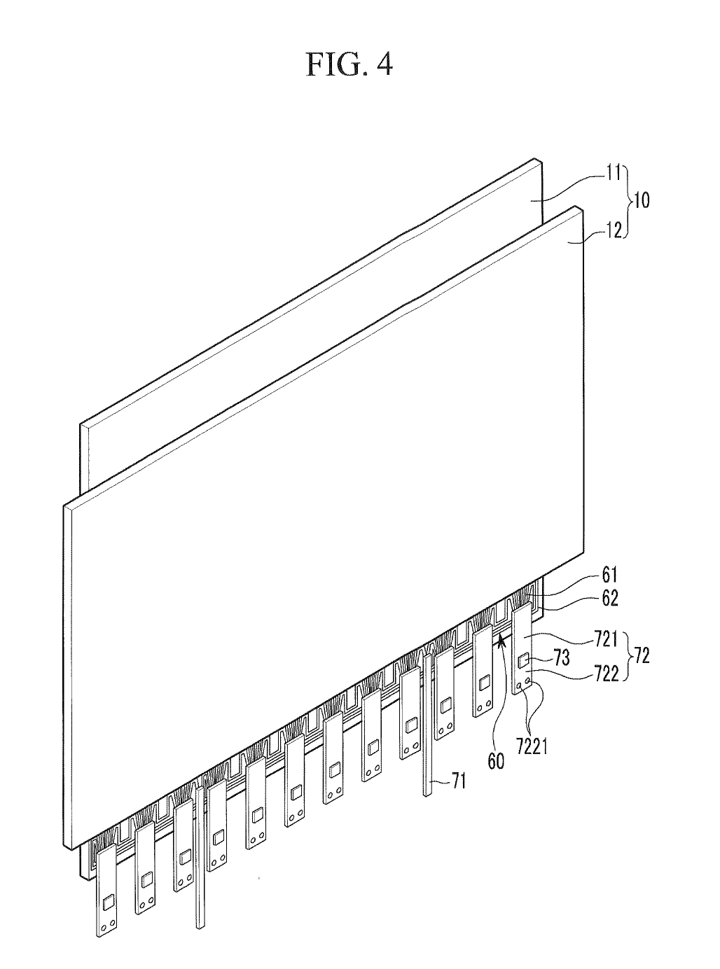

FIG. 4 is a perspective view viewed from an upper front part of the plasma display panel of FIG. 1.

Referring to FIG. 4, the plasma display panel 10 according to an exemplary embodiment of the present invention further includes a circuit pattern 60 so as to control the address electrodes 13.

In addition, referring to FIG. 1 and FIG. 3, the circuit pattern 60 is connected to the logic board assembly 43 through a second tape carrier package 71 (hereinafter referred to as an “interface tape carrier package”) and is connected to each address electrode 13 through a first tape carrier package 72 (hereinafter referred to as a “TCP”).

The circuit pattern 60 may be patterned by a process of forming the address electrode 13 on the rear substrate 11. Therefore, in the manufacturing process, a separate additional process for forming the circuit pattern 60 is not required.

The circuit pattern 60 is formed on the rear substrate 11 at one end of the address electrode 13, and includes terminals 61 that are connected to the respective address electrodes 13 and signal lines 62 that transfer power and control signals that are applied from the logic board assembly 43.

One end of the interface tape carrier package 71 is connected to the logic board assembly 43, and the other end thereof is connected to the signal line 62 of the circuit pattern 60. Therefore, the power and control signals of the logic board assembly 43 are applied to the signal lines 62 of the circuit pattern 60 through the interface tape carrier package 71. At lease one interface tape carrier package 71 is provided so that the logic board assembly 43 is electrically connected to the circuit pattern 60.

The TCP 72 is provided in a plurality, and has a first end 721 that is connected to the circuit pattern 60 and the terminals 61 and a second end 722 that forms a free end.

A drive IC 73 is mounted between the first end 721 and the second end 722.

The first end 721 is connected to the terminals 61 and the signal lines 62 of the circuit pattern 60 so that the drive IC 73 is electrically connected to the terminals 61 and the signal lines 62. In other words, the first end 721 includes input terminals and output terminals (not shown) of the power and control signals.

Therefore, the drive IC 73 is operated according to voltage and control signals applied through the interface tape carrier package 71 and the signal lines 62 to drive the address electrode 13.

Referring back to FIGS. 2 and 3, the TCP 72 is connected to the terminals 61 of the circuit pattern 60 so that it is connected to the address electrode 13, thereby applying the control signal to the address electrode 13. In order to seal between the circuit pattern 60 and the TCP 72 and the circuit pattern 60, a sealing member 50 including a first sealing member 51 and a second sealing member 52 is provided.

For example, the first sealing member 51 and the second sealing member 52 are formed at a misaligned position with respect to each other on either side of the TCP 72. The first sealing member 51 is formed between an end portion of the TCP 72 and a tip of the front substrate 12 facing the end portion to seal between the TCP 72 and the front substrate 12. The second sealing member 52 is formed between an end portion of the circuit pattern 60 and the TCP 72 facing the end portion to seal between the circuit pattern 60, the rear substrate 11, and the TCP 72.

A cover plate 75 is formed to include a horizontal surface 752 and a vertical surface 753 that are at right angles to each other. The vertical surface 753 is mounted on a bent portion 33 of the chassis base 30 by a set screw 32, such that the cover plate 75 covers the TCP 72, the drive IC 73, the interface tape carrier package 71 to protect them.

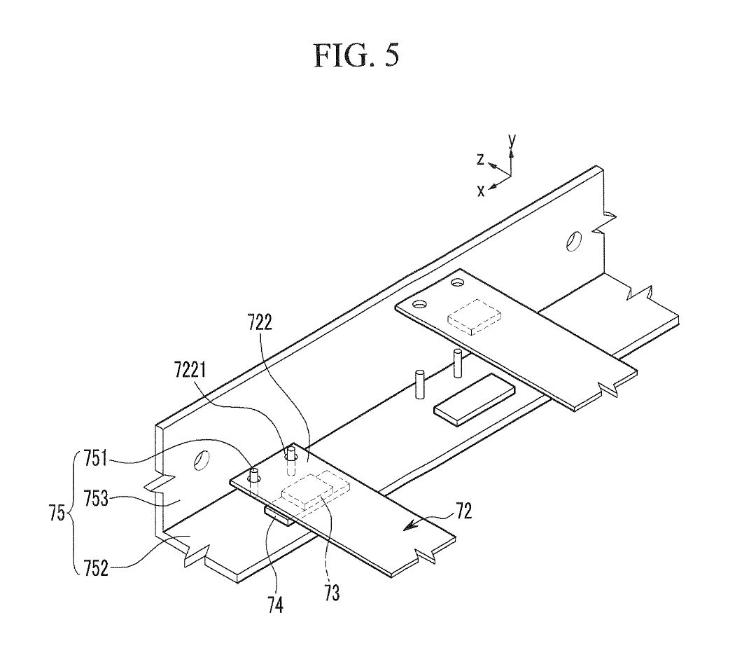

FIG. 5 is an exploded perspective view of the cover plate and the first tape carrier package (TCP). Referring to FIGS. 2, 3, and 5, the cover plate 75 is interconnected with the second end 722 that is the free end of the TCP 72, while covering the interface tape carrier package 71 and the TCP 72.

In the TCP 72, the first end 721 is connected to the circuit pattern 60 and the second end 722 is fixed to the cover plate 75, such that the TCP 72 maintains a stabilized state and the attached state of the circuit pattern 60 and the first end 721 can be firmly maintained. The free end of the TCP 72 maintains the stabilized state within the cover plate 75, such that damage to the TCP 72 and breakage of the drive IC 73 can be prevented.

For example, in order to interconnect the second end 722 of the TCP 72 and the cover plate 75, the TCP 72 has a penetration hole 7221 in the second end 722 and the cover plate 75 has an insertion protrusion 751 that is inserted corresponding to the penetration hole 7221.

One penetration hole 7221 or a plurality of penetration holes 7221 may be formed in the drive IC 73, and as shown, a plurality of penetration holes 7221 may be formed at both sides of the drive IC 73 as pairs. The penetration hole 7221 is formed to be round and the insertion protrusion 751 is formed to be cylindrical to correspond thereto.

The penetration hole 7221 is formed at both sides of the drive IC 73 in the TCP 72, such that the TCP 72 holds the stabilized coupling structure in a width direction when the penetration hole 7221 is coupled to the insertion protrusion 751.

Also, the penetration hole 7221 and the insertion protrusion 751 are respectively formed to be round and cylindrical such that they correspond to each other, so that they are coupled to form a tight coupling structure.

Therefore, the cover plate 75 is mounted on the bent portion 33 of the chassis base 30 by connecting the TCP 72 to the circuit pattern 60 and inserting the insertion protrusion 751 into the penetration hole 7221, such that the motion of the TCP 72 is limited in left and right directions (see FIG. 5).

As such, in the first exemplary embodiment, a coupling error of the penetration hole 7221 of the TCP 72 and the insertion protrusion 751 of the cover plate 75 is minimized, thereby minimizing the motion of the TCP 72.

Referring to FIG. 3, when the plasma display device 1 is disposed in a vertical direction as shown in FIG. 1 and the interface tape carrier package 71 is connected to the circuit pattern 60 and the logic board assembly 43, the interface tape carrier package 71 forms a curved line portion 711. When the interface tape carrier package 71 is in this state, the curved line portion 711 is positioned at the lowest side.

When the TCP 72 is connected to the circuit pattern of the plasma display panel 10 and the cover plate 75 is mounted on the chassis base 30, the TCP 72 is bent (FIG. 2 shows it to be bent state by 90°). In the TCP 72 of this state, the second end 722 that is the free end is positioned between the lower end of the plasma display panel 10 and the cover plate 75.

Therefore, the second end 722 of the TCP 72 is positioned at a lower end than the curved line portion 711 of the interface tape carrier package 71.

In other words, the second end 722 is disposed to be more adjacent to the cover plate 75 than to the curved line portion 711 such that it is easy to apply the heat dissipation structure of the drive IC 73 mounted in the TCP 72.

A heat dissipation pad 74 or thermal grease (not shown) is interposed between the horizontal surface 752 of the cover plate 75 and the TCP 72. The heat dissipation pad 74 or the thermal grease is closely attached corresponding to the drive IC 73 mounted in a TCP 72 to rapidly transfer heat from the drive IC 73 to the cover plate 75 in driving.

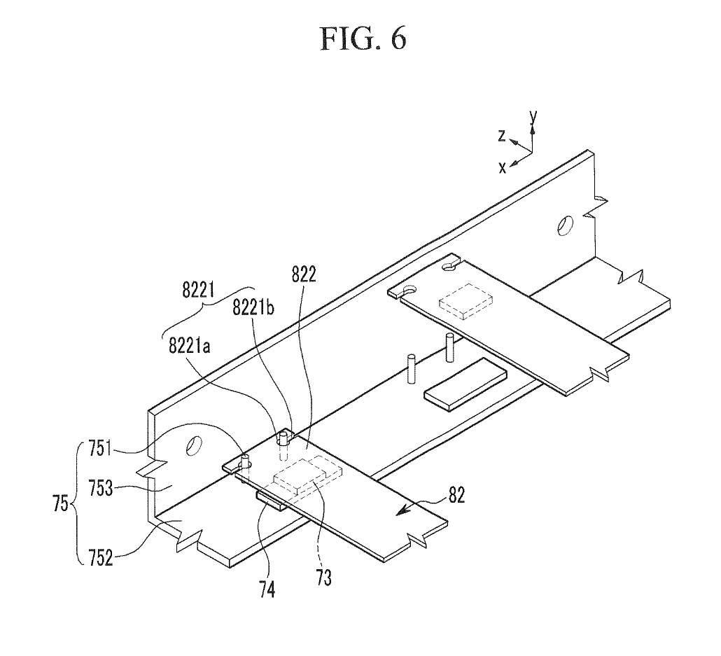

FIG. 6 is an exploded perspective view of the cover plate and the first tape carrier package (TCP) in the plasma display device according to the second exemplary embodiment of the present invention

Herein, different configurations from the first exemplary embodiment will be described.

Referring to FIG. 6, a TCP 82 has an opening groove 8221 of which the side of the second end 822 is opened, and the cover plate 75 has an insertion protrusion 751 that is inserted corresponding to the opening groove 8221.

One opening groove or a pair of opening grooves 8221 may be formed on the TCP 82, and as shown, a pair of opening grooves 8221 may be formed at both sides of the drive IC 73.

The opening groove 8221 includes a circular portion 8221a that is formed to be round and an opening portion 8221b that is cut at a smaller interval than a diameter of the circular portion 8221a and is connected to the circular portion 8221a. The insertion protrusion 751 is formed in a cylindrical shape that corresponds to the circular portion 8221a.

The opening groove 8221 of the second exemplary embodiment includes the opening portion 8221b that is opened to both sides of the TCP 82 from the circular portion 8221a, such that the insertion protrusion 751 can be inserted through the opening portion 8221b and then coupled with the circular portion 8221a.

Therefore, the second exemplary embodiment performs a coupling function more easily than the first exemplary embodiment that mutually couples the opening groove 8221 and the insertion protrusion 751 in a length direction of the insertion protrusion 751.

Also, the opening portion 8221b allows movement between the opening groove 8221 of the TCP 82 and the insertion protrusion 751 of the cover plate 75, thereby increasing the coupling permissible error range when coupling them.

Although not separately shown in the drawings, the exemplary embodiments will be sufficiently practiced by a person of ordinary skill in the art with reference to FIGS. 5 and 6, and therefore the third embodiment of the TCP 72 and the cover plate 75 will be described with reference to FIGS. 5 and 6. For convenience, in the third exemplary embodiment, the reference numerals of FIG. 5 are mainly used, and if necessary, reference numerals of FIG. 6 are selectively used.

In the third exemplary embodiment, the TCP 72 may have the penetration hole 7221 and the opening groove 8221 at both sides of the second end 722, respectively. The cover plate 75 includes the insertion protrusion 751 that is inserted to correspond to the penetration hole 7221 and the opening groove 8221, respectively.

The third exemplary embodiment shows that in the TCP 72, the second end 722 can be formed in various structures (penetration hole and opening groove). Further, the third exemplary embodiment minimizes the motion of the TCP 72 by the penetration hole 7221 (see the first exemplary embodiment), and increases the permissible error by the opening groove 8221 (see the second exemplary embodiment).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel that includes a pair of substrates facing each other and implements images;
a chassis base that supports the plasma display panel at an opposite side to that where the images are implemented;
circuit patterns that include terminals formed on the substrate formed with address electrodes among the pair of substrates and connected to the address electrodes and signal lines applying power and control signals;
a first tape carrier package that has a first end connected to the terminals and a second end forming a free end and that mounts a drive IC between the first end and the second end; and
a cover plate that is mounted on the chassis base while covering the first tape carrier package,
wherein the second end of the first tape carrier package and the cover plate are coupled to each other.

2. The plasma display device of claim 1, wherein the first tape carrier package has penetration holes formed at the second end, and the cover plate includes insertion protrusions that are formed corresponding to the penetration holes and inserted into the penetration holes.

3. The plasma display device of claim 2, wherein the penetration holes are formed at both sides of the drive IC in a pair.

4. The plasma display device of claim 1, wherein the penetration hole is formed to be round, and the insertion protrusion is formed to be cylindrical corresponding thereto.

5. The plasma display device of claim 1, wherein the first tape carrier package has opening grooves whose sides are opened at the second end, and the cover plate includes the insertion protrusions that are formed corresponding to the opening grooves and are inserted into the opening grooves.

6. The plasma display device of claim 5, wherein the opening grooves are formed at both sides of the drive IC as pairs.

7. The plasma display device of claim 6, wherein the opening grooves each include a circular portion corresponding to the insertion protrusion and an opening portion that is smaller than a diameter of the circular portion.

8. The plasma display device of claim 1, wherein the first tape carrier package has the penetration holes and the opening grooves at both sides of the second end, and the cover plate includes the insertion protrusions that are formed corresponding to the penetration holes and the opening grooves and are inserted into the penetration holes and the opening grooves.

9. The plasma display device of claim 1, further comprising:
a printed circuit board assembly mounted on the chassis base at an opposite side of the plasma display panel; and
a second tape carrier package that mutually connects the signal line with the printed circuit board assembly.

10. The plasma display device of claim 9, wherein the printed circuit board assembly to which the second tape carrier package is connected is a logic board assembly that receives video signals from the outside, generates control signals required to control the plasma display panel, and applies them to the printed circuit board assemblies.

11. The plasma display device of claim 9, wherein, in the second tape carrier package is bent between a lower end of the plasma display panel and the cover plate, the second end is disposed to be more adjacent to the cover plate than to a curved line of the second tape carrier package that connects the circuit pattern and the printed circuit board assembly while being bent at the lower end of the plasma display panel.

12. The plasma display device of claim 11, wherein the cover plate includes a horizontal surface and a vertical surface that are at right angles to each other, and further includes a heat dissipation pad that is interposed between the horizontal surface and the second tape carrier package.

13. The plasma display device of claim 12, wherein the drive IC mounted in the first tape carrier package is closely attached to the heat dissipation pad.
